(19) United States
(12) Patent Application Publication
(10) Pub. No.: US 2003/0085246 A1
(43) Pub. Date: May 8, 2003

(54) First aid organizer kit assembly

(76) Inventors: Ron Reisman, Beer Yaacob, IL (US); Shay Ben Zion Lipschitz, East Binyamin (IL)

Correspondence Address: BROWDY AND NEIMARK, P.L.L.C., 624 Ninth Street, N.W., Washington, DC, 20001, US

(21) Appl. No.: 10/223,712

(22) Filed: Aug. 20, 2002

(30) Foreign Application Priority Data
Aug. 21, 2001 (IL) 145019

(51) Int. Cl. B60R 7/00

(52) U.S. Cl. 224/275; 206/570; 206/803

(57) ABSTRACT

A first aid organizer kit assembly hitched onto posts of the head rest of the driver's seat of a vehicle so that in the event of an emergency first aid articles are then readily available. The assembly includes a roll formed by a coilable organizer panel having an array of pockets which accommodate a collection of first aid articles, the panel being wound to create a loaded roll in which the articles are embedded. The loaded roll is nested in a pouch that is attachable to a mounting strip linked to the posts of the head rest so that the strip then lies against the rear of the driver's seat. Should an emergency arise, the pouch is detached from the mounting strip and the roll is taken out of the pouch and unwound to make available the first aid articles.

### BACKGROUND OF THE INVENTION

1. Field of the Invention

This invention relates generally to first aid kits, and in particular to a first aid kit assembly that is hitchable onto the posts of the headrest on the driver's seat of a vehicle, the assembly including an organizer panel loaded with a collection of first aid articles and wound into a roll that is nested in a pouch.

2. Status of Prior Art

First aid refers to emergency treatment administered to an ill or injured individual before professional assistance can be obtained. Thus if a driver of a vehicle as a result of a collision suffers a head injury and is bleeding profusely, then with first aid the head wound can be treated and bandaged at the site of the accident so that the driver is then in condition to be taken to a hospital for professional care. Those who make use of first aid kits and not qualified physicians, nor need then be, for all they are called upon to do is what obviously is required under the circumstances.

With the exception of those buses and taxis which are mandated to carry first aid kits, most private automobiles are without a kit, mainly because a first aid kit cannot be conveniently stored in the interior of the vehicle. First aid kits come in different sizes, depending on the number of first aid articles in the collection thereof that can be crammed into a met box having a hinged cover. A small first aid kit has just as few items and while this kit may be adequate for a camping trip, it falls short of what is desirable for an automobile vulnerable to accidents that may result in serious injuries. Hence a first aid kit suitable for an automobile must carry numerous first aid articles.

A fast aid kit may be stored in a vehicle at several locations e.g. under any of the seats, attached to the floor or to any of the panels etc. However, most likely, such a kit is typically stored in the trunk of the car which already a stored therein personal belongings, a spare tire and tire-changing tools as well as other items accumulated by the car owner. In a typical family car whose passengers are mainly children, the trunk is usually crowded, and the addition of a large first aid kit does not relieve the congestion.

When therefore an emergency situation arises and there is an immediate need for the first aid kit, it then becomes necessary to open the trunk of the vehicle and hunt for the kit. An other problem may occur upon collision is the trunk being jammed in a manner which may prevent it from being opened. Even more so, if an occupant of the vehicle is injured and is not in position to serve himself first aid, there is a problem of passers-by not knowing where the first aid kit is stored within the vehicle.

The nature of the illness or injury which calls for fat aid treatment dice the nature of articles appropriate to this treatment and cannot be anticipated. When therefore a need arises for first aid and use is made of a standard firs aid kit containing an unorganized assortment of first aid articles, one must then search for the appropriate articles.

Inasmuch as a first aid organizer kit assembly in accordance with the invention is adapted to be hitched onto the posts supporting the head rest of a vehicle driver's seat, of prior art interest is the 1998 to Sims U.S. Pat. No. 5,791,614. This patent discloses a hanger that fits onto the posts of the head rest of a driver's seat a pouch being suspended from the hanger.

### SUMMARY OF THE INVENTION

In view of the foregoing, the main object of this invention is to provide a first aid organizer kit assembly which is hitchable onto posts supporting the head rest of the driver's seat in an automobile or other vehicle.

More particularly, an object of this invention is to provide an assembly of the above type in which a collection of first aid articles are stored in an array of pockets formed on a coilable organizer panel which when loaded is wound into a roll in which the articles are protectively embedded.

Also an object of this invention is to provide an assembly of the above type in which the loaded roll is nested in a like-shaped pouch attachable to a mounting strip linked to the head rest posts.

Among the significant advantages of an assembly in accordance with the invention are the following:

A. The first aid kit is stored in the interior of the vehicle and therefore is readily available in the event of an emergency.

B. The first aid articles in he collection thereof are pocketed in an organizer panel so that when specific articles are required with which to administer first aid, they can quickly be located.

C. Thc first aid kit which is hitched onto the head rest posts can be readily detached therefrom so that when an emergency arises the kit can be taken out of the vehicle.

D. When hitched onto the posts of the head rest the first aid assembly then lies against the rear of the driver's seat and in no way interferes with passengers seated behind the driver's seat.

E. The assembly whose components are formed of fabric material may be mass-produced at relatively low cost.

Briefly stated, these objects are attained in a first aid organizer kit assembly hitched onto the posts of the head rest of the driver's seat of a vehicle so that in the event of an emergency, first aid articles are then readily available. The assembly includes a roll formed by a coilable organizer cloth panel having an array of pocket; which accommodate a collection of first aid articles, the panel being wound to create a loaded roll in which the articles are embedded.

The loaded roll is nested in a pouch that is attachable to a mounting strip linked to the posts of the head rest so that the strip then lies against the rear of the driver's seat. Should an emergency arise, the pouch is detached from the mounting strip and the roll is taken out of the pouch and unwound to make available the first aid articles.

### BRIEF DESCRIPTION OF TIE DRAWINGS

For a better understanding of the invention as well as other objects and features thereof, reference is made to the annexed drawings wherein:

FIG. 1 is a perspective view of a first aid organs kit assembly in accordance with the invention bitched onto the posts of the head rest of the driver's scat in an automobile;

FIG. 2 is a side view of the assembly;

FIG. 3 shows the assembly when its pouch is open and the organizer panel attached thereto is unrolled to expose the first aid articles pocketed on the panel;

FIG. 4 illustrates the manner in which the pouch of the assembly which contains a first-aid roll is detached from a mounting strip linked to the head rest posts; and

FIG. 5 is a rear view of the mounting strip.

### DETAILED DESCRIPTION OF THE INVENTION

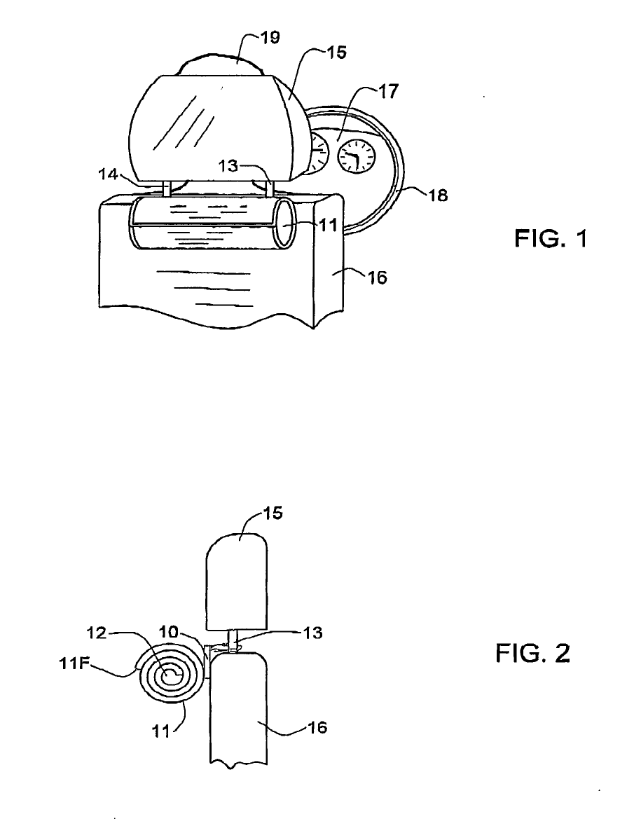

A first aid organizer kit assembly in accordance with the invention, as shown in FIGS. 1 and 2, consists of a mounting strip 110 a pouch 11 attachable to the 2, strip, and a first aid organize roll 12 loaded with first aid articles nested in the pouch. The assembly is adapted to be hitched onto a pair of posts 13 and 14 supporting the head rest 15 above a driver's seat 16 in a vehicle, such as an automobile having a dashboard 17 and a steering wheel 18 in font of a driver 19.

This assembly is installable in any vehicle regardless of its character as long as the vehicle's driver's seat is provided with a head rest whose supporting posts are telescoped in sockets formed in the driver's seat so that the height of the head rest can be adjusted to accommodate the driver of the vehicle.

Strip 10 is formed from a rectangular piece of cloth having, as she in FIGS. 4 and 5, two pairs of eyelets E1 and E2 at the upper margin of the strip adjacent opposite ends thereof. Threaded through the eyelets is a cord 20 which define cord loops L1 and L2 that bridge these eyelets and project therefrom.

To install the strip, the head rest is removed to withdraw posts 13 and 14 from their driver's seat sockets. The loops L1 and L2 are then slipped over the posts and posts 13 and 14 are returned to their sockets, so that now the loops encircle the posts to link the strip thereto whereby the strip 10 then lies against the rear surface of the driver's seat 16 at the upper end thereof.

Pouch 11 which is formed of cloth has a generally cylindrical shape with closed ends and a longitudinally-extending flap 11F The flap is fasted to the front side of the pouch and when unfastened, opals the pouch so that it can receive roll 12.

Strip 10 is provided on its front face as shown in FIG. 4, with a fabric VELCRO fastener band 21 which is either the female (loop) or male (hook) component of the fastener. A band 22 carrying a complementary component is secured to the rear side of pouch 11. Hence the pouch can readily be attached or detached from mounting strip 10.

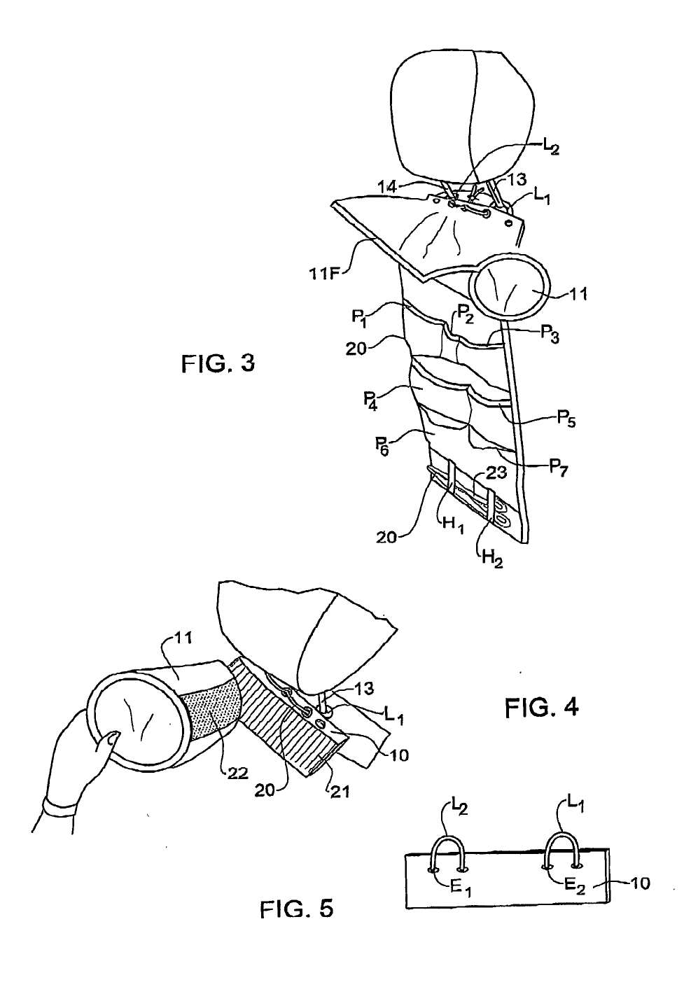

Roll 12, as best seen in FIGS. 2 and 3, is formed by a relatively long cloth panel on whose front face is secured an array of pockets P1 to P7 dimensioned to accommodate an assortment of different fist aid articles. The dimensions of each pocket are such as to snugly receive the article being pocketed therein. The pocket is preferably made of open weave fabric netting so that it can be somewhat expanded. Also secured to the front panel below the pockets are bolsters H1 and H2 to accommodate first aid implements, such as a scissors 23 and a tweezers 24.

The roll panel functions as an organizer, for each first aid article is separately displayed and viewable through the open weave netting of the pocket in which it is stored. Thus the user of the kit can therefore quickly locate the articles he needs. When the panel is fully loaded, it is then wound into the cylindrical roll 20 in which, the first aid articles are protectively embedded:

The cylindrical dimensions of pouch 11 are such as to be able to easily nest the loaded cylindrical roll therein.

The panel forming roll 20 may be independent of the pouch 11 so that one can remove the roll from the pouch which remains attached to the mounting strip. Or one can remove the roll-loaded pouch from mounting strip 10 and then remove the roll from the pouch.

A preferred arrangement is that shown in FIG. 3 in which the upper end of the roll panel 20 is attached to the pouch 11. Then when the kit is put to use, the assembly remains hitched to the head rest posts and the flap 11F of the pouch is raised to permit the panel to unfurl to expose the first aid articles. Hence, in this arrangement, the first aid kit remains in the vehicle and its user selects the articles be needs from the rear of the driver's seat.

The cloth from which the strip, the pouch and the panel is fabricated is preferably a high-strength synthetic fiber, such as nylon, which can be easily be washed and rendered sterile. The occasion to do so is after the first aid kit has been put to emergency use and it is thereafter necessary to reload the roll for future use.

While there has been shown a preferred embodiment of a first aid organizer kit assembly in accordance with the invention, it is to be understood that many changes and modifications may be made therein without departing from the spirit of the invention. Thus instead of a mounting strip, use may be made of a hood that goes over the head rest, with the pouch being attachable to the rear of the hood.

1. A first aid organizer kit assembly adapted to hitch onto posts supporting the head rest of a driver's seat in a vehicle whereby the kit can be stored in the interior of the vehicle in readiness for an emergency, said assembly comprising:
A. a mounting strip sinkable to the posts 50 that it lies against a rear surface of the seat;
B. a pouch attachable to the strip dimensioned to nest a first aid roll; and
C. a first aid roll formed by a coilable organizer panel having pockets therein to accommodate a collection of first aid articles, said panel when loaded by wound into a roll in which the articles are protectively embedded, which roll is nested in the pouch.

2. An assembly as set fore in claim 1, in which the strip is provided at its upper margin with projecting loops which encircle the posts.

3. An assembly as set forth in claim 2, in which the loops are created by threading a cord through eyelets secured to the of the strip.

4. An assembly as set forth in claim 1, in which the pouch is attached to the strip by a Velcro fastener, one component of which is secured to the strip, a complementary component being secured to the pouch.

5. An assembly as set forth in claim 1, in which the pouch has a cylindrical configuration to receive a cylindrical loaded roll.

6. An assembly as set forth in claim 1, in which the strip, the pouch and the panel are fabricated of cloth.

7. An assembly as set forth in claim 6, in which the cloth is fabricated of nylon fibers.

8. An assembly as set forth in claim 1, in which the pockets on the panel are created by netting.

9. A assembly as set fort in claim 8, in which the panel also includes holsters to support first aid implements.

10. In combination;
A. a first aid roll formed by a coilable panel having pockets therein to accommodate first aid articles, said panel, when loaded, being wound into a roll in which the articles are embedded; and
B. a pouch dimensioned to nest the loaded roll.

11. The combination as set forth in claim 10, in which the panel and pouch are fabricated of cloth.

12. A first aid organizer kit assembly adapted to bitch onto posts supporting the head rest of a driver's seat in a vehicle, whereby the kit can be stored in the interior of the vehicle in readiness for an emergency, said assembly comprising;
A. a mount attachable to the posts;
B. a pouch detachably attached to the mount at a rear side of the head rest; and
C. a first aid kit receivable within the pouch.

13. A first aid kit according to claim 12, wherein the pouch accommodates a coilable organizer panel having pockets therein to accommodate a collection of first aid articles, said panel when loaded being wound into a roll in which the articles are protectively embedded.

14. A first aid kit according to claim 12, wherein the pouch is attached to the mount by a Velcro fastener, one component of which is secured to the mount, a complementary component being secured to the pouch.

15. A first aid kit according to claim 12, wherein the pouch has a cylindrical configuration.

16. A first aid kit according to claim 12, wherein the mount is a fixture formed with two post engaging members and a pouch engaging portion for attaching thereto a pouch at a location between the head-rest and the seat, at a rear side thereof.

17. A fist aid organizer kit assembly adapted to hitch onto posts supporting the head rest of a driver's seat in a vehicle, whereby the kit can be stored in the interior of the vehicle in readiness for an emergency, said assembly comprising;
A. a mount detachably attachable to the posts;
B. a pouch attached to the mount at a rear side of the head rest; and
a first aid kit receivable within the pouch.

18. A first aid kit according to claim 18, wherein the mount comprises two post engaging members detachably engageable with the posts.

19. A first aid kit according to any one of the preceding claims wherein a carrying strap is attached to the pouch.
